(19) United States
(12) Patent Application Publication
(10) Pub. No.: US 2025/0336182 A1
(43) Pub. Date: Oct. 30, 2025

(54) METHOD FOR IDENTIFYING TYPE OF SHALE LAMINASET BASED ON ELECTRICAL IMAGING LOGGING

(71) Applicant: CHONGQING UNIVERSITY OF SCIENCE AND TECHNOLOGY, Shapingba District (CN)

(72) Inventors: Fuqiang LAI, Shapingba District (CN); Yu ZENG, Shapingba District (CN); Xianfeng TAN, Shapingba District (CN); Haitao WANG, Shapingba District (CN); Zhaohui HUANG, Shapingba District (CN); Ya YANG, Shapingba District (CN)

(21) Appl. No.: 19/023,529

(22) Filed: Jan. 16, 2025

(30) Foreign Application Priority Data
Apr. 30, 2024 (CN) 202410537891.8

(51) Int. Cl. G06V 10/764; G01V 3/18; G01V 3/38; G06V 10/28; G06V 10/44; G06V 10/762

(52) U.S. Cl. CPC G06V 10/764; G01V 3/18; G01V 3/38; G06V 10/28; G06V 10/457; G06V 10/763

(57) ABSTRACT

The present application relates to a method for identifying a type of a shale laminaset based on electrical imaging logging, includes loading and decoding electrical imaging data, and preprocessing the electrical imaging data to generate electrical imaging polar plate image data. An image center cluster is initialized by K-means++ algorithm, finding a new cluster center by iteration according to a mean value after calculating a Euclidean distance, and completing clustering after a threshold or a limit of times is reached. N clustered values are binarized to obtain an end-to-end connected matrix conforming to a principle of wellbore imaging, then a circularly connected component labeling algorithm is carried out, and sinusoidal bedding interface fitting is performed after extracting pixels of laminae by a bedding clustering algorithm. The laminae of a shale gas reservoir is then divided based on electrical imaging logging clustering response characteristic value ranges for different laminasets.

### CROSS REFERENCE TO RELATED APPLICATION

This patent application claims the benefit and priority of Chinese Patent Application No. 202410537891.8, filed with the China National Intellectual Property Administration on Apr. 30, 2024, the disclosure of which is incorporated by reference herein in its entirety as part of the present application.

### TECHNICAL FIELD

The present disclosure relates to the technical field of applications of electrical imaging logging information, and in particular, to a method for identifying a type of a shale laminaset based on electrical imaging logging.

### BACKGROUND

At present, laminae have recorded the paleoclimate and the properties of fossil water when shale was deposited, and their development also restricts the quality of shale reservoirs and the hydraulic fracturing effect of the shale, and is an important evaluation indicator, in addition to total content of organic carbon w (TOC), effective porosity, brittle mineral, and gas content, etc., for the shale reservoirs.

In the prior art, the formation boundary is identified by image processing methods such as edge detection, image segmentation, and edge tracking and matching, and a sinusoidal bedding interface is extracted using Hough transform or modified Hough transform or even human-machine interaction; meanwhile, type division is achieved by means of cores, microslices, and X-ray diffraction, etc. The ultrahigh resolution of electrical imaging logging allows for intuitive observation and outlining of reservoir features such as fractures, voids, and beddings from images.

However, in the above-mentioned prior art, formation interfaces, especially bedding planes, in an electrical imaging logging image are displayed through subtle gray scale changes within beddings. Adjacent interfaces are very close to each other and the edges are weak, and the trajectories of these interfaces cannot be extracted accurately by the image processing methods such as edge detection, image segmentation, and edge tracking and matching. The Hough transform method is time-consuming and laborious, and can hardly identify low-quality images and partly destructed image data. Moreover, the method of type division by means of cores, microslices, and X-ray diffraction, etc. is time-consuming and laborious, and can only describe cored intervals.

### SUMMARY

An objective of the present disclosure is to provide a method for identifying a type of a shale laminaset based on electrical imaging logging that can solve the problems in the prior art, i.e., formation interfaces, especially bedding planes, in an electrical imaging logging image are displayed through subtle gray scale changes within beddings; adjacent interfaces are very close to each other and the edges are weak, and the trajectories of these interfaces cannot be extracted accurately by the image processing methods such as edge detection, image segmentation, and edge tracking and matching; the Hough transform method is time-consuming and laborious, and can hardly identify low-quality images and partly destructed image data; moreover, the method of type division by means of cores, microslices, and X-ray diffraction, etc. is time-consuming and laborious, and can only describe cored intervals.

To achieve the above objective, the present disclosure provides a method for identifying a type of a shale laminaset based on electrical imaging logging, including: loading and decoding electrical imaging data, and preprocessing the electrical imaging data to generate electrical imaging polar plate image data.

The data from a floating-point type is converted to an unsigned integer type, then setting a blank strip to a null value on a dynamic map, and finally equalizing a full image by setting a window length and a stride, thereby obtaining a dynamic gray-scale map.

An image center cluster is initialized by K-means++ algorithm, finding a new cluster center by iteration according to a mean value after calculating a Euclidean distance, and completing clustering after a threshold or a limit of times is reached.

After binarizing N clustered values, a matrix end is connected to end to better conform to a principle of wellbore imaging.

Then a circularly connected component labeling algorithm is carried out, and end-to-end connected components are merged to obtain coordinate points of closed laminae.

Sinusoidal bedding interface fitting is performed after extracting pixels of laminae by a bedding clustering algorithm; and laminae of a shale gas reservoir is divided based on electrical imaging logging clustering response characteristic value ranges for different laminasets, and development density parameters of the corresponding laminasets are calculated.

In the dynamic gray-scale map, a data point is randomly selected from a data set as an initial center point, and for a subsequent cluster center point, a shortest distance of each data point to a current selected cluster center point set, namely the square of a distance to a nearest cluster center point, is calculated, with a calculation model: D(x)²=minᵢ∥x−cᵢ|∥², where D(x)² represents the square of a distance of a data point x to a cluster center point, and D represents the distance; mini represents selecting a minimum value after calculating distances for all cluster center points, and i in mini is an index, representing an ith cluster center point; //x−cᵢ// represents a Euclidean distance of the data point x to the ith cluster center point ci, and //⋅// represents a norm or distance of a vector.

A probability distribution is calculated, which represents a probability of selecting next cluster center point, where the probability is inversely proportional to the square of a distance to ensure that a data point further away from a selected center point has a greater probability of being selected, with a calculation model:

$$P ( x ) = \frac{{D ( x )}^{2}}{{Σ}_{{x}^{′}} {D ( {x}^{′} )}^{2}} ;$$

next cluster center point is randomly selected from the data set with the probability distribution; and the process is repeated until K initial cluster center points are selected, thereby completing a K-means++ initialization process, where P(x) represents a probability of selecting the data point x as next cluster center point; P represents the probability; D(x)² represents the square of a distance of the data point x to the cluster center point, and the distance is as mentioned above; Σx′D(x′)² represents summating the squares of distances of all data points x′ to the cluster center point, and Σ represents summation.

For each data point xᵢ, distances of the data point to all the cluster center points are calculated, and a cluster center point cⱼ having a shortest distance is selected, which is represented by a Euclidean distance metric; and the data point xᵢ is assigned to the cluster Cⱼ, with a calculation model: Cⱼ={xᵢ: ∥xᵢ−cₕ∥₂≤∥xᵢ−cₖ∥², ∀k, 1≤k≤K}, where Cⱼ represents that a data point xᵢ is assigned to a cluster j, and C represents the cluster; xᵢ represents an ith data point, and xᵢ is the data point; cⱼ represents a center point of the cluster j, and cⱼ is the cluster center point; //xᵢ−cⱼ// represents a Euclidean distance of the data point xᵢ to the cluster center point cⱼ; and ∀k represents for all the cluster center points ck, 1≤k≤K, where K is a total number of clusters.

For each cluster Cⱼ, a center point cⱼ thereof is recalculated, that is, a mean value of all data points in the cluster is obtained, which is to be used as a new cluster center point for next iteration, with a calculation model:

$${c}_{j} = \frac{1}{\vert {C}_{j} \vert} {\sum }_{{x}_{i} ∈ {C}_{j}} {x}_{i}$$

where cⱼ represents the center point of the cluster j, and cⱼ is the cluster center point; Cⱼ represents a set of all data points in the cluster j, and Cⱼ is a set of data points; |Cⱼ| represents a number of the data points in the cluster j, and |⋅| represents a size of the set; xᵢ∈CⱼΣxᵢ represents summating coordinates of all the data points xi in the cluster j; and 1/|Cⱼ| represents a reciprocal of the number of the data points for calculating the mean value of the data points.

Laminae of a shale gas reservoir are divided into an organic clay laminaset, a siliceous clay laminaset, and a calcareous clay laminaset.

In circularly connected component labeling, a calculation model is as follows:

$${B}_{K} = [ \begin{matrix}{a}_{11} & ⋯ & {a}_{1 n} & {a}_{11} \\ ⋮ & ⋱ & ⋮ & ⋮ \\ {a}_{m 1} & ⋯ & {a}_{mn} & {a}_{m 1}\end{matrix} ] ,$$

where K is an assumed number of clusters, and a blank strip is neglected; C₁, C₂, . . . , C_{K} are point sets obtained after clustering; Cᵢ is a point set of an ith class; points corresponding to K classes are used to form K binary images, denoted as B₁, B₂, . . . B_{K}, and a first column of B_{K} is added to an end of the matrix.

Eight-connected component labeling is performed on each binary image to obtain labeled image sets L₁, L₂, . . . , L_{K}.

A unique value u of a last column of L_{K} is calculated, and a vertical coordinate set corresponding to elements having values equal to u in the last column is found; a horizontal coordinate set X is a first column of data coordinates, which are all 0, with a calculation model: Y=arg where(L_{K:,-1}=u), where Y represents the found vertical coordinate set, which is an index set; L_{K:,-1} represents a last column of a matrix L, and L is a matrix; K: represents taking all rows; −1 represents taking data of the last column; and arg where(⋅) represents finding an index set of elements meeting a condition.

A unique value u₂ of points of X and Y in L_{K} is calculated, and an amplitude of all points having values equal to u₂ in L_{K} is set to u, with a calculation model: Lₖ [Lₖ==u₂]=u, where u₂ represents the unique value of the points of X and Y, and u₂ is a unique value; Lₖ [Lₖ==u₂] represents finding all elements having values equal to u₂ from the matrix Lₖ; and u represents a value to be updated.

Finally, the last column is deleted to achieve the circularly connected component labeling algorithm.

The performing sinusoidal bedding interface fitting after extracting pixels of laminae by a bedding clustering algorithm includes:
randomly initializing three parameters, namely an amplitude, a phase, and a depth, during which a calculation model is as follows: y=A·sin(x+φ)+h₀;
where y represents a display value of a formation on electrical imaging; A represents an amplitude of formation display, namely a magnitude of a formation amplitude; x represents a position coordinate expanded along a cylindrical well wall; φ represents a phase, namely a phase offset of a sinusoidal function; and h₀ represents a reference height of the formation;
predicting the three parameters by a random forest, and then inputting the three predicted parameters as initialized parameters to a sinusoidal fitting algorithm, adding three new parameters fitted by the sinusoidal fitting algorithm to a parameter pool, and then performing continuous loop iteration, thereby realizing parameter initialization by the random forest;
vectorizing data to increase a calculation speed;
sequentially calculating a residual, a Jacobian matrix, and an increment direction, determining whether fitting is continued or a result is output according to a condition, and finally adding the output result to the parameter pool.

The vectorizing data to increase a calculation speed includes the following substeps:
assuming n data points, with a calculation model: (xᵢ, yᵢ)_{i=1, 2, . . . , n}, where n represents a number of the data points, n being a positive integer; xᵢ represents a horizontal coordinate of an ith data point, i ranging from 1 to n; yᵢ represents a vertical coordinate of the ith data point, i ranging from 1 to n; and i represents an index of a data point, i being an integer and ranging from 1 to n;
fitting a nonlinear function, with a calculation model:
f(x; φ, A, h)=A·sin(x+φ)+h₀, where f(x;φ,A,h) represents the nonlinear function, where x is an independent variable, and φ, A, and h are parameters; φ represents the phase parameter, affecting the phase offset of the sinusoidal function; A represents the amplitude parameter, affecting the amplitude of the sinusoidal function; and h represents the reference height parameter.

Data points are expressed in a form of a vector, with calculation models: X=[x₁, x₂, . . . , xₙ]^{T}, Y=[y₁, y₂, . . . , yₙ]^{T}, where X represents a horizontal coordinate vector of the data points, which is a column vector and contains horizontal coordinates x₁, x₂, . . . , xₙ of all the data points, where n is the number of the data points; Y represents a vertical coordinate vector of the data points, which is a column vector and contains vertical coordinates y₁, y₂, . . . , yₙ of all the data points, and n is also the number of the data points.

A residual vector R is calculated, where each element is a difference between an actual observed value and a model predicted value, with a calculation model: R=Y−f(x; φ, A, h), where R represents the residual vector, which is a column vector and contains a residual of each data point, namely the difference between the actual observed value and the model predicted value; Y represents the vertical coordinate vector of the data points, namely the actual observed value; f(x;φ,A,h) represents the model predicted value, which is a nonlinear function value calculated according to the given parameters φ, A, h, and the horizontal coordinate x of a data point.

By vectorized residual calculation, the residuals of the whole data set are calculated efficiently, and the residuals are used in subsequent steps for parameter updating and fitting optimization.

A Jacobian matrix is a partial derivative matrix of a model function to a parameter vector, and each element thereof represents a partial derivative of the model function to a certain parameter, with a calculation model:
Δf(x; φ, A, h)=f(x; φ, A+ΔA, h)−f(x; φ, A, h), where ΔA represents a micro-increment of the amplitude A, which is a small positive number to calculate the partial derivative; Δf(x;φ,A,h) represents a variation of the model function f(x;φ,A,h), namely a variation of a model function value when the amplitude A is increased by ΔA; f(x;φ,A+ΔA,h) represents a new model function value calculated after the amplitude A is increased by ΔA; and f(x;φ,A,h) represents an original model function value, namely a value of the amplitude A.

A model for calculating the partial derivative of the amplitude A is as follows:

$$\frac{\partial f ( x ; φ , A , h )}{\partial A} \approx \frac{Δ f ( x ; φ , A , h )}{Δ A}$$

where ∂f(x;φ,A,h)/∂A represents the partial derivative of the amplitude A, namely a rate of change of the function f(x;φ,A,h) with respect to the amplitude A; and Δf(x;φ,A,h)/ΔA represents a ratio of a variation of the model function f(x;φ,A,h) to a variation of the amplitude A.

A calculation model for a partial derivative of the model function to a phase difference is as follows:

$$\frac{\partial f ( x ; φ , A , h )}{\partial φ} = A * cos ( x + φ ) ,$$

where ∂f(x;φ,A,h)/∂φ represents a partial derivative of the phase difference φ, namely a rate of change of the function f(x;φ,A,h) with respect to the phase difference φ; A represents the amplitude, which is a parameter in a cos function; and cos(x+y) represents a cosine value of x+φ, where x is an independent variable.

A calculation model for constructing the Jacobian matrix is as follows:

$$J = [ \frac{\partial f ( x ; φ , A , h )}{\partial A} , \frac{\partial f ( x ; φ , A , h )}{\partial φ} , \frac{\partial f ( x ; φ , A , h )}{\partial h} ]$$

$$J = [ \frac{Δ f ( x ; φ , A , h )}{Δ A} , A * cos ( x + φ ) , 1 ] ,$$

and the Jacobian matrix is calculated and then used in each iteration of Levenberg-Marquardt algorithm for parameter updating and fitting optimization;
where J represents the Jacobian matrix, which is a row vector and contains partial derivatives of the model function f(x;φ,A,h) with respect to the parameters A, φ, and h; ∂f(x;φ,A,h)/∂A represents the partial derivative of the model function f(x;φ,A,h) with respect to the amplitude A, namely a rate of change of the amplitude; ∂f(x;φ,A,h)/∂φ represents the partial derivative of the model function f(x;φ,A,h) with respect to the phase difference φ, namely a rate of change of the phase difference; and ∂f(x;φ,A,h)/∂h represents the partial derivative of the model function f(x;φ,A,h) with respect to the reference height h, namely a rate of change of the reference height.

A calculation model for calculating an increment direction is as follows: Δp=(J^{T}*J+λ*diag(J^{T}*J))⁻¹*J^{T}*R, where diag(J^{T}*J) is configured to adjust an effect of a parameter change on the increment direction; and λ is an adjustment factor for controlling a size of a stride, namely reducing by λ if a fitting result after parameter updating becomes better and increasing by λ if a fitting result after parameter updating becomes worse.

Δp represents a variation of a parameter, which is a column vector for indicating how the parameter is adjusted to minimize a residual at a current parameter value; λ represents a regularization parameter for controlling an intensity of regularization; J^{T} represents a transpose of the Jacobian matrix J; J^{T}*J represents a product of the transpose of the Jacobian matrix J and the Jacobian matrix; diag(J^{T}*J) represents converting the product of the transpose of the Jacobian matrix J and the Jacobian matrix to a diagonal matrix, namely only retaining elements in a main diagonal; J^{T}*R represents a product of the transpose of the Jacobian matrix J and a residual vector R; and (J^{T}*J+λ*diag(J^{T}*J))⁻¹ represents an inverse matrix of the matrix (J^{T}*J+λ*diag(J^{T}*J)).

A quadratic sum of a new residual vector is calculated after parameter estimated values are updated, and compared with a last value; if the quadratic sum is less than the last value and a preset convergence threshold is reached, algorithm iteration is stopped, and parameter estimation is regarded as having converged; if the quadratic sum is less than the last value and the convergence threshold is not reached, the iteration is continued, parameter values are updated, and residuals are recalculated. If the quadratic sum is greater than the last value, a stride of parameter updating is adjusted according to current parameter estimated values and residual vector, and the iteration is continued, with a calculation model:

$$condition 5 = \{ {R}_{last}^{2} - ( Y - {f ( x ; p + Δ p )}^{2} ) > threshold ;$$

where R²ₗₐₛₜ represents a quadratic sum of a residual vector of a last iteration; Y−f(x;p+Δp)² represents the quadratic sum of the new residual vector calculated after the parameter values are updated, threshold represents the preset convergence threshold for determining a change in residual is small enough, and if the change in residual is less than the threshold, the parameter estimated is regarded as having converged; condition5 represents an iteration stopping condition; if R²ₗₐₛₜ minus the quadratic sum of the new residual vector is greater than the threshold, the iteration is continued; otherwise, the iteration is stopped.

The method for identifying a type of a shale laminaset based on electrical imaging logging of the present disclosure has the following beneficial effects: with the bedding clustering algorithm, a formation boundary can be identified accurately, and direct, rapid, and accurate extraction of boundaries can be achieved. Then, with the modified Levenberg-Marquardt algorithm for lamina identification, efficient, accurate, and strong robust identification of sinusoids can be achieved. Finally, the bedding clustering algorithm can effectively avoid the case of no lamina between two sinusoids. An efficient thickness calculation method is adopted for thickness calculation. When calculating a density, repeated calculation of a lamina can be directly avoided according to a central depth of the lamina.

### BRIEF DESCRIPTION OF THE DRAWINGS

In order to clearly illustrate the technical solutions in the examples of the present application or in the prior art, the accompanying drawings required in the description of the examples and the prior art will be briefly described below.

FIG. 1 is a comparison diagram of an original image with a clustering algorithm according to the present disclosure;

FIG. 2 is a comparison diagram of an eight-connected component labeling algorithm with a circularly connected component labeling algorithm according to the present disclosure;

FIG. 3 is a comparison diagram of an original image with a bedding clustering algorithm according to the present disclosure;

FIG. 4 is a trajectory diagram and an expanded diagram of a wellbore and a formation according to the present disclosure;

FIG. 5 is a flowchart of parameter initialization according to the present disclosure;

FIG. 6 shows an original picture and a final effect picture of parameter pool data according to the present disclosure;

FIG. 7 shows a typical feature map of an organic clay laminaset of Z9 well according to the present disclosure;

FIG. 8 shows a typical feature map of a siliceous clay laminaset of Z10 well according to the present disclosure;

FIG. 9 shows a typical feature map of a calcareous clay laminaset of Z9 well according to the present disclosure;

FIG. 10 shows clustering density maps of three laminasets of X3 well according to the present disclosure;

FIG. 11 shows a comprehensive result map of identification of laminaset types of X9 well according to the present disclosure; and

FIG. 12 is a diagram showing a general technical route of the present disclosure.

### DETAILED DESCRIPTION OF THE EMBODIMENTS

The embodiments of the present disclosure are described below in detail. Examples of the embodiments are shown in the drawings. The embodiments described below with reference to the accompanying drawings are exemplary, and are intended to explain the present disclosure but should not be construed as a limitation to the present disclosure.

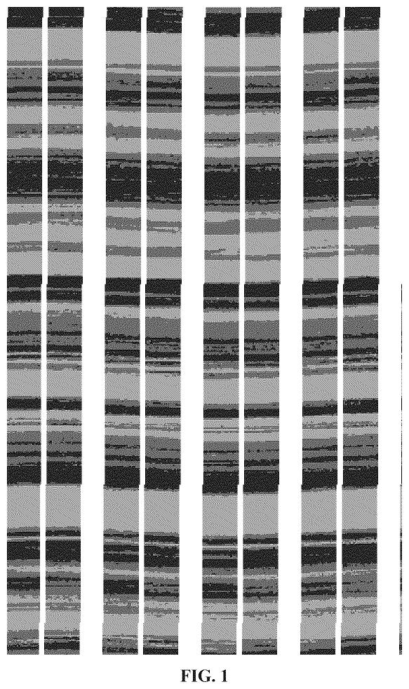

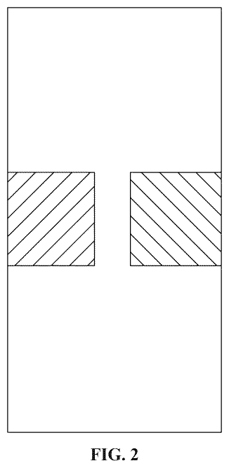

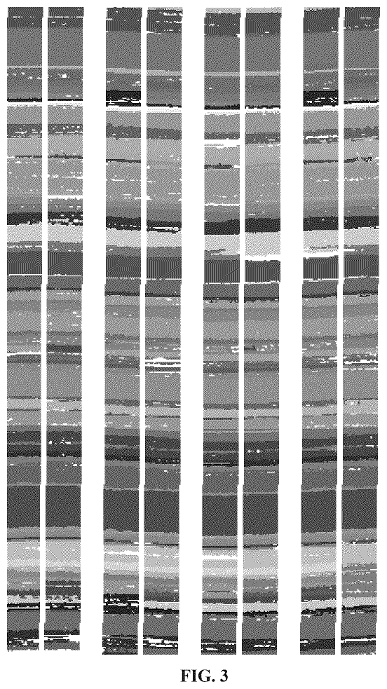

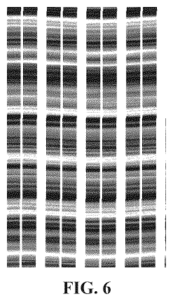

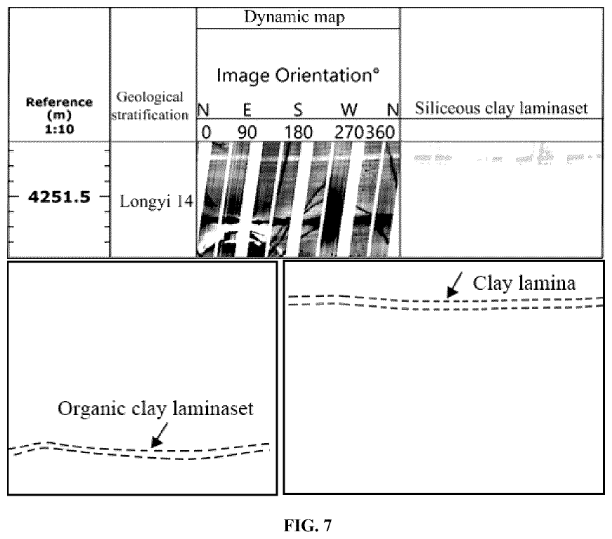

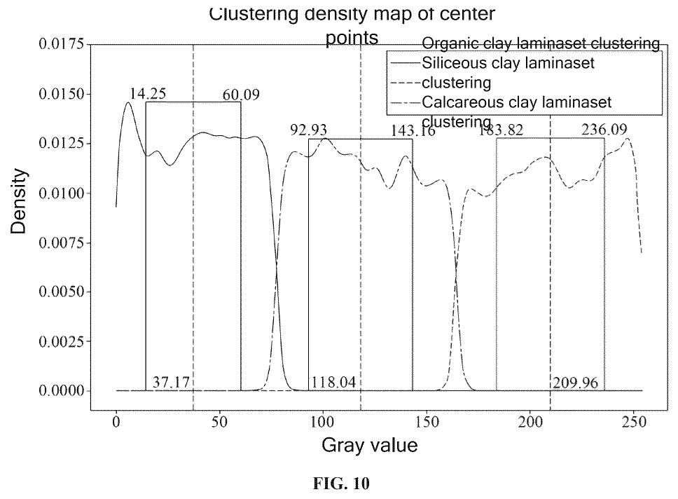

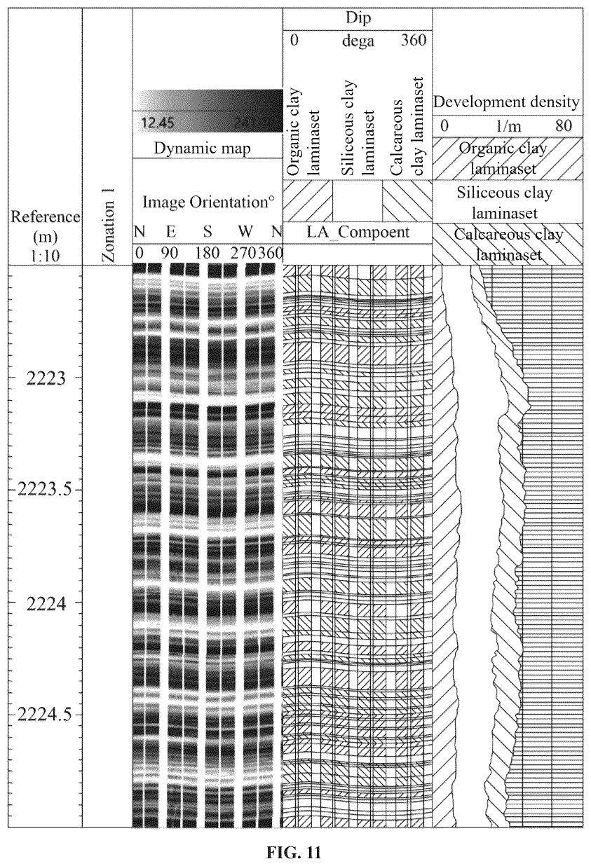

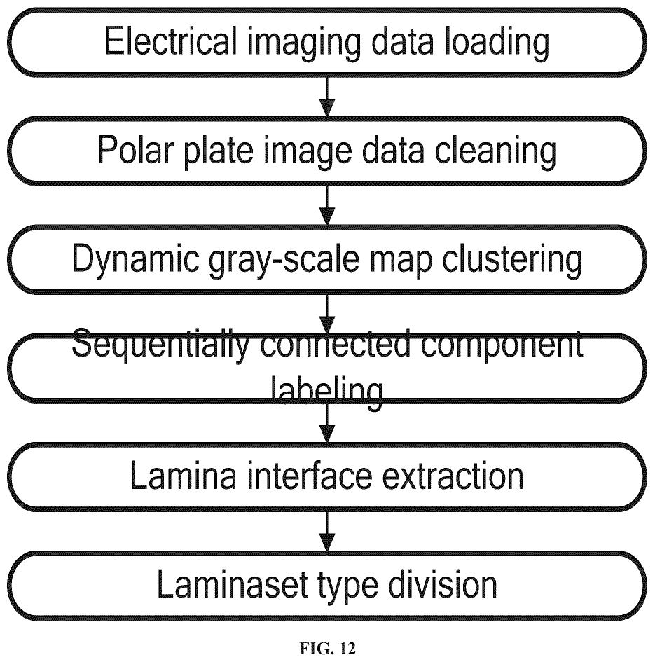

Referring to FIG. 1 to FIG. 12, the present disclosure provides a method for identifying a type of a shale laminaset based on electrical imaging logging, including the following steps.

Electrical imaging data is loaded and decoded, and the electrical imaging data is preprocessed to generate electrical imaging polar plate image data.

The data is converted from a floating-point type to an unsigned integer type, and then a blank strip is set to a null value on a dynamic map, and finally a full image is equalized by setting a window length and a stride, thereby obtaining a dynamic gray-scale map.

An image center cluster is initialized by K-means++ algorithm; a new cluster center is found by iteration according to a mean value after calculating a Euclidean distance, and clustering is completed after a threshold or a limit of times is reached.

After binarizing N clustered values, a matrix is connected end to end to better conform to a principle of wellbore imaging.

Then, a circularly connected component labeling algorithm is carried out, and end-to-end connected components are merged to obtain coordinate points of closed laminae.

Sinusoidal bedding interface fitting can be performed after extracting pixels of laminae by a bedding clustering algorithm.

Laminae of a shale gas reservoir are divided based on electrical imaging logging clustering response characteristic value ranges for different laminasets, and development density parameters of the corresponding laminasets are calculated.

Further, in the dynamic gray-scale map, a data point is randomly selected from a data set as an initial center point, and for a subsequent cluster center point, a shortest distance of each data point to a current selected cluster center point set, namely the square of a distance to a nearest cluster center point, is calculated, with a calculation model: D(x)²=minᵢ∥x−cᵢ∥²;
where D(x)² represents the square of a distance of a data point x to a cluster center point, and D represents the distance; mini represents selecting a minimum value after calculating distances for all cluster center points, and i in mini is an index, representing an ith cluster center point; //x−cᵢ// represents a Euclidean distance of the data point x to the ith cluster center point ci, and //⋅// represents a norm or distance of a vector.

A probability distribution is calculated, which represents a probability of selecting next cluster center point, where the probability is inversely proportional to the square of a distance to ensure that a data point further away from a selected center point has a greater probability of being selected, with a calculation model:

$$P ( x ) = \frac{{D ( x )}^{2}}{{Σ}_{{x}^{′}} {D ( {x}^{′} )}^{2}} ;$$

next cluster center point is randomly selected from the data set with the probability distribution; and the process is repeated until K initial cluster center points are selected, thereby completing a K-means++ initialization process;

where P(x) represents a probability of selecting the data point x as next cluster center point; P represents the probability; D(x)² represents the square of a distance of the data point x to the cluster center point, and the distance is as mentioned above; Σx′D(x′)² represents summating the squares of distances of all data points x′ to the cluster center point, and Σ represents summation.

For each data point xᵢ, distances of the data point to all the cluster center points are calculated, and a cluster center point cⱼ having a shortest distance is selected, which is represented by a Euclidean distance metric; and the data point xᵢ is assigned to the cluster Cⱼ, with a calculation model: Cⱼ={xᵢ: ∥xᵢ−cⱼ∥²≤∥xᵢ−cₖ∥², ∀k, 1≤k≤K},
where Cⱼ represents that a data point xᵢ is assigned to a cluster j, and C represents the cluster; xᵢ represents an ith data point, and xᵢ is the data point; cⱼ represents a center point of the cluster j, and cⱼ is the cluster center point; //xᵢ−cⱼ// represents a Euclidean distance of the data point xᵢ to the cluster center point cⱼ; and ∀k represents for all the cluster center points ck, 1≤k≤K, where K is a total number of clusters.

For each cluster Cⱼ, a center point cⱼ thereof is recalculated, that is, a mean value of all data points in the cluster is obtained, which is to be used as a new cluster center point for next iteration, with a calculation model:

$${c}_{j} = \frac{1}{\vert {C}_{j} \vert} {\sum }_{{x}_{i} ∈ {C}_{j}} {x}_{i}$$

where cⱼ represents the center point of the cluster j, and cⱼ is the cluster center point; Cⱼ represents a set of all data points in the cluster j, and Cⱼ is a set of data points; |Cⱼ| represents a number of the data points in the cluster j, and |⋅| represents a size of the set; xᵢ∈CⱼΣxᵢ represents summating coordinates of all the data points xi in the cluster j; and 1/|Cⱼ| represents a reciprocal of the number of the data points for calculating the mean value of the data points.

Further, laminae of a shale gas reservoir are divided into an organic clay laminaset, a siliceous clay laminaset, and a calcareous clay laminaset.

Further, in circularly connected component labeling, a calculation model is as follows:

$${B}_{K} = [ \begin{matrix}{a}_{11} & ⋯ & {a}_{1 n} & {a}_{11} \\ ⋮ & ⋱ & ⋮ & ⋮ \\ {a}_{m 1} & ⋯ & {a}_{mn} & {a}_{m 1}\end{matrix} ] ,$$

where K is an assumed number of clusters, and a blank strip is neglected; C₁, C₂, . . . C_{K}, are point sets obtained after clustering; Cᵢ is a point set of an ith class; points corresponding to K classes are used to form K binary images, denoted as B₁, B₂, . . . B_{K}, and a first column of B_{K} is added to an end of the matrix.

Eight-connected component labeling is performed on each binary image to obtain labeled image sets L₁, L₂, . . . L_{K}.

A unique value u of a last column of L_{K} is calculated, and a vertical coordinate set corresponding to elements having values equal to u in the last column is found; a horizontal coordinate set X is a first column of data coordinates, which are all 0, with a calculation model:

$$Y = argwhere ( {L}_{K : , - 1} = u ) ;$$

where Y represents the found vertical coordinate set, which is an index set; L_{K:,-1} represents a last column of a matrix L, and L is a matrix; K: represents taking all rows; −1 represents taking data of the last column; and arg where(⋅) represents finding an index set of elements meeting a condition.

A unique value u₂ of points of X and Y in L_{K} is calculated, and an amplitude of all points having values equal to u₂ in L_{K} is set to u, with a calculation model: Lₖ [Lₖ==u₂]=u;
where u₂ represents the unique value of the points of X and Y, and u₂ is a unique value; Lₖ [Lₖ==u₂] represents finding all elements having values equal to u₂ from the matrix Lₖ; and u represents a value to be updated.

The last column is deleted to achieve the circularly connected component labeling algorithm.

Further, the performing sinusoidal bedding interface fitting after extracting pixels of laminae by a bedding clustering algorithm includes the following steps.

Three parameters, namely an amplitude, a phase, and a depth, are randomly initialized, during which a calculation model is as follows: y=A·sin(x+φ)+h₀;

where y represents a display value of a formation on electrical imaging; A represents an amplitude of formation display, namely a magnitude of a formation amplitude; x represents a position coordinate expanded along a cylindrical well wall; φ represents a phase, namely a phase offset of a sinusoidal function; and h₀ represents a reference height of the formation.

The three parameters are predicted by a random forest, and then the three predicted parameters are input as initialized parameters to a sinusoidal fitting algorithm; three new parameters fitted by the sinusoidal fitting algorithm are added to a parameter pool, and then continuous loop iteration is performed, thereby realizing parameter initialization by the random forest.

Data is vectorized to increase a calculation speed.

A residual, a Jacobian matrix, and an increment direction are sequentially calculated; whether fitting is continued or a result is output is determined according to a condition; and finally, the output result is added to the parameter pool.

Further, the vectorizing data to increase a calculation speed includes the following substeps.

It is assumed that there are n data points, with a calculation model: (xᵢ, yᵢ)_{i=1, 2, . . . , n} where n represents a number of the data points, n being a positive integer; xᵢ represents a horizontal coordinate of an ith data point, i ranging from 1 to n; yᵢ represents a vertical coordinate of the ith data point, i ranging from 1 to n; and i represents an index of a data point, i being an integer and ranging from 1 to n;

The objective is to fit a nonlinear function, with a calculation model:

$$f ( x ; φ , A , h ) = A \cdot sin ( x + φ ) + {h}_{0} ;$$

where f(x;φ,A,h) represents the nonlinear function, where x is an independent variable, and φ, A, and h are parameters; φ represents the phase parameter, affecting the phase offset of the sinusoidal function; A represents the amplitude parameter, affecting the amplitude of the sinusoidal function; and h represents the reference height parameter.

Data points are expressed in a form of a vector, with calculation models: X=[x₁, x₂, . . . , xₙ]^{T}, Y=[y₁, y₂, . . . , yₙ]^{T};
where X represents a horizontal coordinate vector of the data points, which is a column vector and contains horizontal coordinates x₁, x₂, . . . , xₙ of all the data points, where n is the number of the data points; Y represents a vertical coordinate vector of the data points, which is a column vector and contains vertical coordinates y₁, y₂, . . . , yₙ of all the data points, and n is also the number of the data points.

The objective is to calculate a residual vector R, where each element is a difference between an actual observed value and a model predicted value, with a calculation model: R=Y−f(x;φ,A,h);

where R represents the residual vector, which is a column vector and contains a residual of each data point, namely the difference between the actual observed value and the model predicted value; Y represents the vertical coordinate vector of the data points, namely the actual observed value; f(x;φ,A,h) represents the model predicted value, which is a nonlinear function value calculated according to the given parameters φ, A, h, and the horizontal coordinate x of a data point.

By vectorized residual calculation, the residuals of the whole data set are calculated efficiently, and the residuals are used in subsequent steps for parameter updating and fitting optimization.

Further, a Jacobian matrix is a partial derivative matrix of a model function to a parameter vector, and each element thereof represents a partial derivative of the model function to a certain parameter, with a calculation model:

$$Δ f ( x ; φ , A , h ) = f ( x ; φ , A + Δ A , h ) - f ( x ; φ , A , h )$$

where ΔA represents a micro-increment of the amplitude A, which is a small positive number to calculate the partial derivative; Δf(x;φ,A,h) represents a variation of the model function f(x;φ,A,h), namely a variation of a model function value when the amplitude A is increased by ΔA; f(x;φ,A+ΔA,h) represents a new model function value calculated after the amplitude A is increased by ΔA; and f(x;φ,A,h) represents an original model function value, namely a value of the amplitude A.

A model for calculating the partial derivative of the amplitude A is as follows:

$$\frac{\partial f ( x ; φ , A , h )}{\partial A} \approx \frac{Δ f ( x ; φ , A , h )}{Δ A}$$

where ∂f(x;φ,A,h)/∂A represents the partial derivative of the amplitude A, namely a rate of change of the function f(x;φ,A,h) with respect to the amplitude A; and Δf(x;φ,A,h)/ΔA represents a ratio of a variation of the model function f(x;φ,A,h) to a variation of the amplitude A.
a calculation model for a partial derivative of the model function to a phase difference is as follows:

$$\frac{\partial f ( x ; φ , A , h )}{\partial φ} = A * cos ( x + φ )$$

where ∂f(x;φ,A,h)/∂φ represents a partial derivative of the phase difference φ, namely a rate of change of the function f(x;φ,A,h) with respect to the phase difference φ; A represents the amplitude, which is a parameter in a cos function; and cos(x+y) represents a cosine value of x+y, where x is an independent variable.

A calculation model for constructing the Jacobian matrix is as follows:

$$J = [ \frac{\partial f ( x ; φ , A , h )}{\partial A} , \frac{\partial f ( x ; φ , A , h )}{\partial φ} , \frac{\partial f ( x ; φ , A , h )}{\partial h} ]$$

$$J = [ \frac{Δ f ( x ; φ , A , h )}{Δ A} , A * cos ( x + φ ) , 1 ] ,$$

and the Jacobian matrix is calculated and then used in each iteration of Levenberg-Marquardt algorithm for parameter updating and fitting optimization;
where J represents the Jacobian matrix, which is a row vector and contains partial derivatives of the model function f(x;φ,A,h) with respect to the parameters A, φ, and h; ∂f(x;φ,A,h)/∂A represents the partial derivative of the model function f(x;φ,A,h) with respect to the amplitude A, namely a rate of change of the amplitude; ∂f(x;φ,A,h)/∂φ represents the partial derivative of the model function f(x;φ,A,h) with respect to the phase difference φ, namely a rate of change of the phase difference; and ∂f(x;φ,A,h)/∂h represents the partial derivative of the model function f(x;φ,A,h) with respect to the reference height h, namely a rate of change of the reference height.

Further, a calculation model for calculating an increment direction is as follows: Δp=(J^{T}*J+λ*diag(J^{T}*J))⁻¹*J^{T}*R, where diag(J^{T}*J) is configured to adjust an effect of a parameter change on the increment direction; and λ is an adjustment factor for controlling a size of a stride, namely reducing by λ if a fitting result after parameter updating becomes better and increasing by λ if a fitting result after parameter updating becomes worse;
where Δp represents a variation of a parameter, which is a column vector for indicating how the parameter is adjusted to minimize a residual at a current parameter value; λ represents a regularization parameter for controlling an intensity of regularization; J^{T} represents a transpose of the Jacobian matrix J; J^{T}*J represents a product of the transpose of the Jacobian matrix J and the Jacobian matrix; diag(J^{T}*J) represents converting the product of the transpose of the Jacobian matrix J and the Jacobian matrix to a diagonal matrix, namely only retaining elements in a main diagonal; J^{T}*R represents a product of the transpose of the Jacobian matrix J and a residual vector R; and (J^{T}*J+λ*diag(J^{T}*J)⁻¹ represents an inverse matrix of the matrix (J^{T}*J+λ*diag(J^{T}*J)).

Further, a quadratic sum of a new residual vector is calculated after parameter estimated values are updated, and compared with a last value; if the quadratic sum is less than the last value and a preset convergence threshold is reached, algorithm iteration is stopped, and parameter estimation is regarded as having converged; if the quadratic sum is less than the last value and the convergence threshold is not reached, the iteration is continued, parameter values are updated, and residuals are recalculated; if the quadratic sum is greater than the last value, a stride of parameter updating is adjusted according to current parameter estimated values and residual vector, and the iteration is continued, with a calculation model:

$$condition 5 = \{ {R}_{last}^{2} - ( Y - {f ( x ; p + Δ p )}^{2} ) > threshold ;$$

where R²ₗₐₛₜ represents a quadratic sum of a residual vector of a last iteration; Y−f(x;p+Δp)² represents the quadratic sum of the new residual vector calculated after the parameter values are updated; threshold represents the preset convergence threshold for determining a change in residual is small enough, and if the change in residual is less than the threshold, the parameter estimated is regarded as having converged; condition5 represents an iteration stopping condition; if R²ₗₐₛₜ minus the quadratic sum of the new residual vector is greater than the threshold, the iteration is continued; otherwise, the iteration is stopped.

In this embodiment, in reverse thinking, a bedding clustering algorithm is proposed. The entirety of different laminasets is separated firstly, and then boundaries are extracted directly, rapidly, and accurately according to the body, for detection of next step on sinusoids of laminaset boundaries. Traditionally, the identification of a sinusoid of an interface from an imaged image is generally achieved using Hough transform and the least square method. Although the Hough transform can identify a plurality of curves once, it is low in speed and accuracy, and is prone to confuse upper and lower beddings. The least square method is high in speed and accuracy, but can hardly identify boundaries of irregular laminasets. Taking the advantages and disadvantages of the two algorithms into comprehensive consideration, the modified Levenberg-Marquardt algorithm of the present disclosure for lamina identification can achieve efficient, accurate, and strong robust identification of sinusoids. Since an irregular formation interface results in obscure demarcation of boundary pixels, type division may be seriously affected in case of thin laminasets. Meanwhile, there might be no lamina between bedding interfaces, and therefore, an error may occur in calculating a lamina thickness with a height difference of two sinusoids. The bedding clustering algorithm of the present disclosure can effectively avoid the case of no lamina between two sinusoids. An efficient thickness calculation method is adopted for thickness calculation. When calculating a density, repeated calculation of a lamina can be directly avoided according to a central depth of the lamina.

When extracting lamina coordinate points based on the bedding clustering algorithm, firstly, electrical imaging data is loaded and decoded, and the electrical imaging data is preprocessed to generate electrical imaging polar plate image data. An image center cluster is then initialized by K-means++ algorithm; a new cluster center is found by iteration according to a mean value after calculating a Euclidean distance, and clustering is completed after a threshold or a limit of times is reached. After binarizing N clustered values, a matrix is connected end to end to better conform to a principle of wellbore imaging. Then, a circularly connected component labeling algorithm is carried out, and end-to-end connected components are merged to obtain coordinate points of closed laminae.

When loading the electrical imaging data and cleaning the data, the acquired original electrical imaging data is in dlis format, and needs to be loaded and decoded. The original data is preprocessed to generate the electrical imaging polar plate image data. At this point, the original polar plate data is extremely huge for a long interval. Taking a formation microresistivity imaging (FMI) full borehole dynamic map as an example, the imaging of a 500 m interval will have 70.92 million data points, and each data point is of a floating-point type. Therefore, data cleaning is required. Firstly, the data is converted from the floating-point type to the unsigned integer type, and then the blank strip is set to the null value on the dynamic map, and finally the full image is equalized by setting the window length and the stride, thereby obtaining the dynamic gray-scale map.

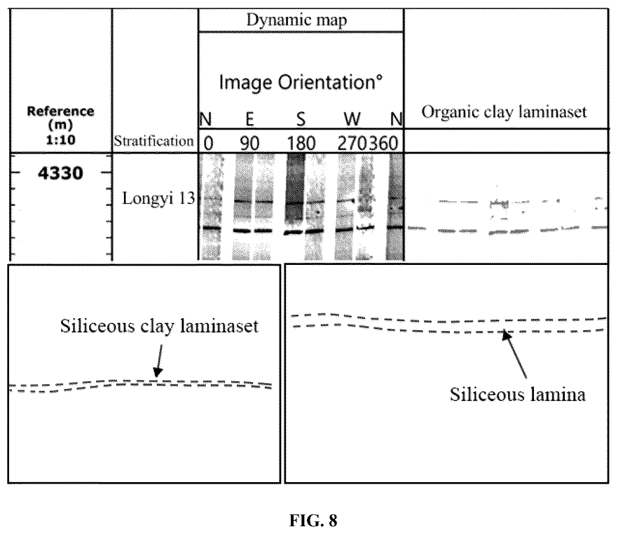

Dynamic gray-scale map clustering is then performed: an initial center selection mechanism of K-means++ is introduced into Mini-Batch K-means, and the convergence rate and the clustering effect of the algorithm are increased by selecting a more representative initial center. Meanwhile, by means of Mini-Batch learning, the computational overhead of each iteration is reduced such that the algorithm is more suitable for processing large-scale data. After being processed with the clustering algorithm (assuming K=6, with the blank strip being neglected), the data volume is reduced from N*256 to N*6, but the effect on the laminae can be neglected. With reference to FIG. 8, the integrity of the data is maintained while significantly reducing the data volume.

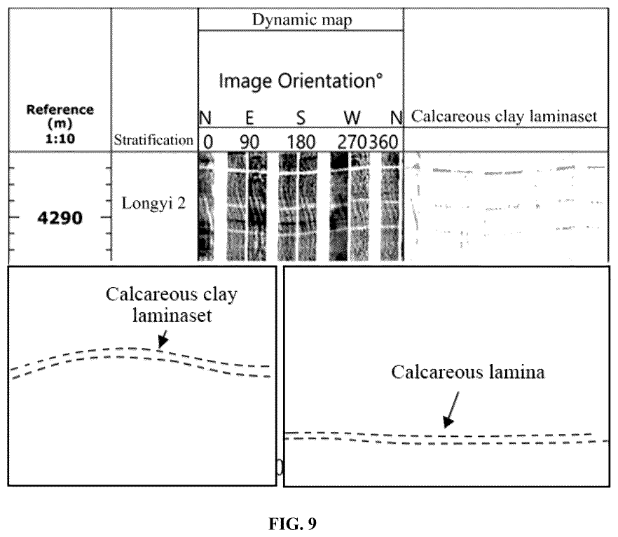

For circularly connected component labeling, since a cylindrical shape is actually measured by underground electrical imaging logging, there is a polar plate spacing, and the polar plate data might be lost. Therefore, a circularly connected component labeling algorithm is designed, which effectively solves the problem of end-to-end connection of images, thereby avoiding lamina identification failure caused by loss of middle polar plate data. The connectivity of images is neglected when a conventional eight-connected component labeling algorithm is applied to wellbore imaging, and components disconnected in middle but actually connected cannot be identified, as shown in FIG. 9. The circularly connected component labeling algorithm realizes connected component labeling on cylindrical images by connecting the images end to end. Finally, K classes of labels are merged, thereby obtaining a complete connected component labeled graph. Each color represents a separate laminaset.

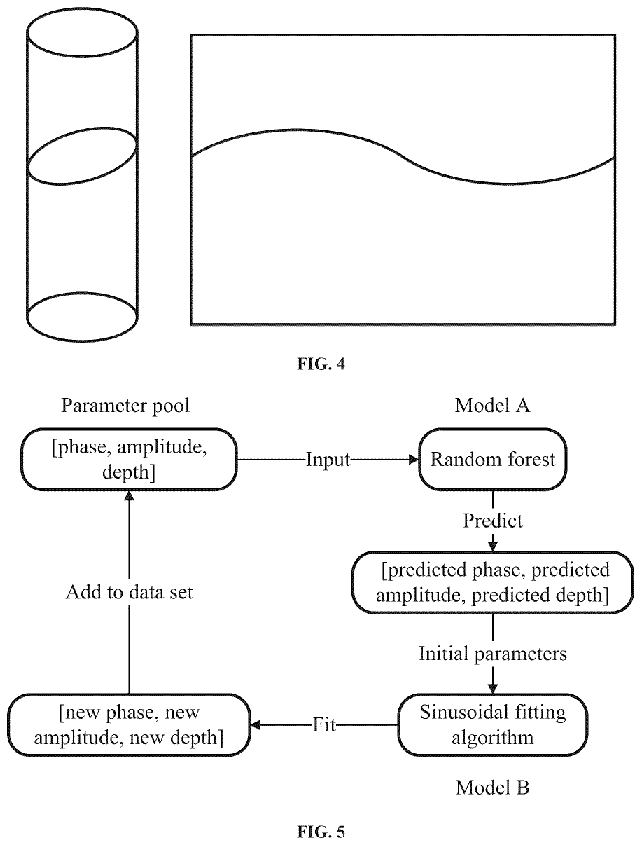

In a modified Levenberg-Marquardt fitted lamina interface, as shown in FIG. 4, in an expanded image of a well wall, a bedding plane of a cut borehole is manifested as a single-cycle sinusoid, and therefore, sinusoidal fitting needs to be performed on the bedding plane.

Sinusoidal bedding interface fitting can be performed after extracting pixels of laminae by a bedding clustering algorithm. Firstly, three parameters, namely an amplitude, a phase, and a depth, are randomly initialized, and then data is vectorized to increase a calculation speed. A residual, a Jacobian matrix, and an increment direction are sequentially calculated; whether fitting is continued or a result is output is determined according to a condition; and finally, the output result is added to the parameter pool. The data of the parameter pool is input to the random forest for predicting initial parameters. As calculation iteration progresses, the prediction of initialized parameters is increasingly accurate, and the calculation speed is increasingly higher.

In parameter initialization by the random forest, compared with a traditional initialization method, e.g., randomly or by selection according to experience, not only can the calculation quantity be greatly increased, but also in case of a certain number of iterations, the accuracy will decrease. Therefore, the present disclosure adopts the random forest in machining learning to initialize parameters.

In vectorized residual calculation, compared with calculating the residual of each data point one by one, the data points are expressed as a vector, and vectorization operations (such as matrix multiplication and element level operation) are used to calculate the residuals of the whole data set. Thus, the calculation efficiency can be improved by optimized implementation of matrix operations.

In the calculation of the Jacobian matrix by an analytical-numerical synthetic method, a partial derivative is calculated using an analytical method or a numerical method. The numerical method is suitable for ordinary nonlinear functions, and is easy to implement but limited in calculation accuracy. The analytical method is suitable for simple and derivable functions and can provide accurate derivative calculation results, but its derivation process might be tedious. A sinusoid at a fixed frequency of 1 is fitted, and it is considered that the accuracy requirement on the phase in electrical imaging is greater than the amplitude. Therefore, an approach of combined analytical and numerical methods is proposed for calculation.

Verification is then performed by actual drawing: the data in the parameter pool is plotted into the original map again after the completion of sine matching, as shown in FIG. 9. Since boundaries between laminae is more concerned, upper boundaries or lower boundaries of the laminae are usually extracted first.

Imaging logging response characteristics of laminasets are then analyzed: a sampling rate of electrical imaging is 0.00254 m, but the laminae still cannot be depicted meticulously. The laminae seen in electrical imaging actually are a set of many laminae. The present disclosure is intended to define the laminae in electrical imaging as laminasets, in a range of 0.254-10 cm. An interface of the laminasets often presents a set of regions with abnormal electrical conductivity parallel or near parallel to one another. If the downhole formation is tilted, the image presents a sinusoidal wave distribution.

With the idea of demarcating an imaging logging image using a core with identification results of lamina development types by the core and a slice, a response characteristic of the same laminaset on the imaged image are determined. By multi-well clustering statistical analysis, it can be obtained that the response characteristic of the organic clay laminaset on electrical imaging is generally black, with a gray value range: [16.67-81.03], and a clustering center value: 48.85;
the response characteristic of the siliceous clay laminaset on electrical imaging is generally brown, with a gray value range: [95.98-169.66], and a clustering center value: 132.82; and
the response characteristic of the calcareous clay laminaset on electrical imaging is generally luminous yellow, with a gray value range: [177.86-239.53], and a clustering center value: 208.69.

Finally, the types of the laminasets are divided: the laminae of the shale gas reservoir are divided into three main classes: organic clay laminaset, siliceous clay laminaset, and calcareous clay laminaset, based on electrical imaging logging clustering response characteristic value ranges for different laminasets, and development density parameters of the corresponding laminasets are calculated.

The foregoing disclosure is merely one or more preferred embodiments of the present disclosure, and should not be used to limit the scope of rights of the present disclosure. A person of ordinary skill in the art may understand that all or some procedures for implementing the foregoing embodiments, and equivalent changes made according to the claims of the present disclosure shall still fall within the protection scope of the present disclosure.

What is claimed is:

1. A method for identifying a type of a shale laminaset based on electrical imaging logging, comprising:
loading and decoding electrical imaging data, and preprocessing the electrical imaging data to generate electrical imaging polar plate image data;
converting the data from a floating-point type to an unsigned integer type, then setting a blank strip to a null value on a dynamic map, and finally equalizing a full image by setting a window length and a stride, thereby obtaining a dynamic gray-scale map;
initializing an image center cluster by K-means++ algorithm, finding a new cluster center by iteration according to a mean value after calculating a Euclidean distance, and completing clustering after a threshold or a limit of times is reached;
after binarizing N clustered values, connecting a matrix end to end to better conform to a principle of wellbore imaging;
then executing a circularly connected component labeling algorithm, and merging end-to-end connected components to obtain coordinate points of closed laminae;
performing sinusoidal bedding interface fitting after extracting pixels of laminae by a bedding clustering algorithm; and
dividing laminae of a shale gas reservoir based on electrical imaging logging clustering response characteristic value ranges for different laminasets and calculating development density parameters of the corresponding laminasets.

2. The method for identifying a type of a shale laminaset based on electrical imaging logging according to claim 1, wherein,
in the dynamic gray-scale map, a data point is randomly selected from a data set as an initial center point, and for a subsequent cluster center point, a shortest distance of each data point to a current selected cluster center point set, namely the square of a distance to a nearest cluster center point, is calculated, with a calculation model: D(x)²=minᵢ∥x−cᵢ∥²;
where D(x)² represents the square of a distance of a data point x to a cluster center point, and D represents the distance; mini represents selecting a minimum value after calculating distances for all cluster center points, and i in mini is an index, representing an ith cluster center point; //x−cᵢ// represents a Euclidean distance of the data point x to the ith cluster center point cᵢ, and //⋅// represents a norm or distance of a vector;
calculating a probability distribution, which represents a probability of selecting next cluster center point, wherein the probability is inversely proportional to the square of a distance to ensure that a data point further away from a selected center point has a greater probability of being selected, with a calculation model:
$$P ( x ) = \frac{{D ( x )}^{2}}{{Σ}_{{x}^{′}} {D ( {x}^{′} )}^{2}} ;$$
next cluster center point is randomly selected from the data set with the probability distribution; and the process is repeated until K initial cluster center points are selected, thereby completing a K-means++ initialization process;
where P(x) represents a probability of selecting the data point x as next cluster center point; P represents the probability; D(x)² represents the square of a distance of the data point x to the cluster center point, and the distance is as mentioned above; Σ_{x′}D(x′)² represents summating the squares of distances of all data points x′ to the cluster center point, and Σ represents summation;
for each data point xᵢ, distances of the data point to all the cluster center points are calculated, and a cluster center point cⱼ having a shortest distance is selected, which is represented by a Euclidean distance metric; and the data point xᵢ is assigned to the cluster Cⱼ, with a calculation model: Cⱼ={xᵢ: ∥xᵢ−cⱼ∥²≤∥xᵢ−cₖ∥², ∀k, 1≤k≤K},
where Cⱼ represents that a data point xᵢ is assigned to a cluster j, and C represents the cluster; xᵢ represents an ith data point, and xᵢ is the data point; cⱼ represents a center point of the cluster j, and cⱼ is the cluster center point; //xᵢ−cⱼ// represents a Euclidean distance of the data point xᵢ to the cluster center point cⱼ; and ∀k represents for all the cluster center points ck, 1≤k≤K, wherein K is a total number of clusters;
for each cluster Cⱼ, a center point cⱼ thereof is recalculated, that is, a mean value of all data points in the cluster is obtained, which is to be used as a new cluster center point for next iteration, with a calculation model:
$${c}_{j} = \frac{1}{\vert {C}_{j} \vert} {\sum }_{{x}_{i} ∈ {C}_{j}} {x}_{i}$$
where cⱼ represents the center point of the cluster j, and cⱼ is the cluster center point; Cⱼ represents a set of all data points in the cluster j, and Cⱼ is a set of data points; |Cⱼ| represents a number of the data points in the cluster j, and |⋅| represents a size of the set; xᵢ∈CⱼΣxᵢ represents summating coordinates of all the data points xi in the cluster j; and 1/|Cⱼ| represents a reciprocal of the number of the data points for calculating the mean value of the data points.

3. The method for identifying a type of a shale laminaset based on electrical imaging logging according to claim 2, wherein laminae of a shale gas reservoir are divided into an organic clay laminaset, a siliceous clay laminaset, and a calcareous clay laminaset.

4. The method for identifying a type of a shale laminaset based on electrical imaging logging according to claim 3, wherein,
in circularly connected component labeling, a calculation model is as follows:
$${B}_{K} = [ \begin{matrix}{a}_{11} & ⋯ & {a}_{1 n} & {a}_{11} \\ ⋮ & ⋱ & ⋮ & ⋮ \\ {a}_{m 1} & ⋯ & {a}_{mn} & {a}_{m 1}\end{matrix} ] ,$$
wherein K is an assumed number of clusters, and a blank strip is neglected; C₁, C₂, . . . , C_{K} are point sets obtained after clustering; Cᵢ is a point set of an ith class; points corresponding to K classes are used to form K binary images, denoted as B₁, B₂, . . . B_{K}, and a first column of B_{K} is added to an end of the matrix;
eight-connected component labeling is performed on each binary image to obtain labeled image sets L₁, L₂, . . . L_{K};
a unique value u of a last column of L_{K} is calculated, and a vertical coordinate set corresponding to elements having values equal to u in the last column is found; a horizontal coordinate set X is a first column of data coordinates, which are all 0, with a calculation model:
$$Y = argwhere ( {L}_{K : , - 1} = u ) ;$$
where Y represents the found vertical coordinate set, which is an index set; L_{K:,-1} represents a last column of a matrix L, and L is a matrix; K: represents taking all rows; −1 represents taking data of the last column; and arg where(⋅) represents finding an index set of elements meeting a condition;
a unique value u₂ of points of X and Y in L_{K} is calculated, and an amplitude of all points having values equal to u₂ in L_{K} is set to u, with a calculation model: Lₖ [Lₖ==u₂]=u;
where u₂ represents the unique value of the points of X and Y, and u₂ is a unique value; Lₖ [Lₖ==u₂] represents finding all elements having values equal to u₂ from the matrix Lₖ; and u represents a value to be updated; and
deleting the last column to achieve the circularly connected component labeling algorithm.

5. The method for identifying a type of a shale laminaset based on electrical imaging logging according to claim 4, wherein the performing sinusoidal bedding interface fitting after extracting pixels of laminae by a bedding clustering algorithm comprises:
randomly initializing three parameters, namely an amplitude, a phase, and a depth, during which a calculation model is as follows: y=A·sin(x+φ)+h₀;
where y represents a display value of a formation on electrical imaging, A represents an amplitude of formation display, namely a magnitude of a formation amplitude, x represents a position coordinate expanded along a cylindrical well wall, φ represents a phase, namely a phase offset of a sinusoidal function, and h₀ represents a reference height of the formation;
predicting the three parameters by a random forest, and then inputting the three predicted parameters as initialized parameters to a sinusoidal fitting algorithm, adding three new parameters fitted by the sinusoidal fitting algorithm to a parameter pool, and then performing continuous loop iteration, thereby realizing parameter initialization by the random forest;
vectorizing data to increase a calculation speed; and
sequentially calculating a residual, a Jacobian matrix, and an increment direction, determining whether fitting is continued or a result is output according to a condition, and finally adding the output result to the parameter pool.

6. The method for identifying a type of a shale laminaset based on electrical imaging logging according to claim 5, wherein the vectorizing data to increase a calculation speed comprises the following substeps:
assuming n data points, with a calculation model: (xᵢ, yᵢ)_{i=1, 2, . . . , n};
where n represents a number of the data points, n being a positive integer; xᵢ represents a horizontal coordinate of an ith data point, i ranging from 1 to n; yᵢ represents a vertical coordinate of the ith data point, i ranging from 1 to n; and i represents an index of a data point, i being an integer and ranging from 1 to n;
fitting a nonlinear function, with a calculation model
$$f ( x ; φ , A , h ) = A \cdot sin ( x + φ ) + {h}_{0} ;$$
where f(x;φ,A,h) represents the nonlinear function, wherein x is an independent variable, and φ, A, and h are parameters, φ represents the phase parameter, affecting the phase offset of the sinusoidal function, A represents the amplitude parameter, affecting the amplitude of the sinusoidal function, and h represents the reference height parameter;
expressing data points in a form of a vector, with calculation models: X=[x₁, x₂, . . . , xₙ]^{T}, Y=[y₁, y₂, . . . , yₙ]^{T};
where X represents a horizontal coordinate vector of the data points, which is a column vector and contains horizontal coordinates x₁, x₂, . . . , xₙ of all the data points, wherein n is the number of the data points, Y represents a vertical coordinate vector of the data points, which is a column vector and contains vertical coordinates y₁, y₂, . . . , yₙ of all the data points, and n is also the number of the data points; and
calculating a residual vector R, wherein each element is a difference between an actual observed value and a model predicted value, with a calculation model: R=Y−f(x; φ, A, h);
where R represents the residual vector, which is a column vector and contains a residual of each data point, namely the difference between the actual observed value and the model predicted value; Y represents the vertical coordinate vector of the data points, namely the actual observed value; f(x;φ,A,h) represents the model predicted value, which is a nonlinear function value calculated according to the given parameters φ, A, h, and the horizontal coordinate x of a data point;
by vectorized residual calculation, calculating the residuals of the whole data set efficiently, and the residuals are used in subsequent steps for parameter updating and fitting optimization.

7. The method for identifying a type of a shale laminaset based on electrical imaging logging according to claim 6, wherein a Jacobian matrix is a partial derivative matrix of a model function to a parameter vector, and each element thereof represents a partial derivative of the model function to a certain parameter, with a calculation model;
$$Δ f ( x ; φ , A , h ) = f ( x ; φ , A + Δ A , h ) - f ( x ; φ , A , h ) ,$$
where ΔA represents a micro-increment of the amplitude A, which is a small positive number to calculate the partial derivative; Δf(x;φ,A,h) represents a variation of the model function f(x;φ,A,h), namely a variation of a model function value when the amplitude A is increased by ΔA; f(x;φ,A+ΔA,h) represents a new model function value calculated after the amplitude A is increased by ΔA; and f(x;φ,A,h) represents an original model function value, namely a value of the amplitude A;
a model for calculating the partial derivative of the amplitude A is as follows;
$$\frac{\partial f ( x ; φ , A , h )}{\partial A} \approx \frac{Δ f ( x ; φ , A , h )}{Δ A}$$
where ∂f(x;φ,A,h)/∂A represents the partial derivative of the amplitude A, namely a rate of change of the function f(x;φ,A,h) with respect to the amplitude A, and Δf(x;φ,A,h)/ΔA represents a ratio of a variation of the model function f(x;φ,A,h) to a variation of the amplitude A;
a calculation model for a partial derivative of the model function to a phase difference is as follows:
$$\frac{\partial f ( x ; φ , A , h )}{\partial φ} = A * cos ( x + φ ) ,$$
where ∂f(x;φ,A,h)/∂φ represents a partial derivative of the phase difference φ, namely a rate of change of the function f(x;φ,A,h) with respect to the phase difference φ; A represents the amplitude, which is a parameter in a cos function; and cos(x+φ) represents a cosine value of x+φ, wherein x is an independent variable;
a calculation model for constructing the Jacobian matrix is as follows;
$$J = [ \frac{\partial f ( x ; φ , A , h )}{\partial A} , \frac{\partial f ( x ; φ , A , h )}{\partial φ} , \frac{\partial f ( x ; φ , A , h )}{\partial h} ]$$
$$J = [ \frac{Δ f ( x ; φ , A , h )}{Δ A} , A * cos ( x + φ ) , 1 ] ,$$
and the Jacobian matrix is calculated and then used in each iteration of Levenberg-Marquardt algorithm for parameter updating and fitting optimization;
where J represents the Jacobian matrix, which is a row vector and contains partial derivatives of the model function f(x;φ,A,h) with respect to the parameters A, φ, and h, ∂f(x;φ,A,h)/∂A represents the partial derivative of the model function f(x;φ,A,h) with respect to the amplitude A, namely a rate of change of the amplitude, ∂f(x;φ,A,h)/∂φ represents the partial derivative of the model function f(x;φ,A,h) with respect to the phase difference φ, namely a rate of change of the phase difference, and ∂f(x;φ,A,h)/∂h represents the partial derivative of the model function f(x;φ,A,h) with respect to the reference height h, namely a rate of change of the reference height.

8. The method for identifying a type of a shale laminaset based on electrical imaging logging according to claim 7, wherein,
a calculation model for calculating an increment direction is as follows: Δp=(J^{T}*J+λ*diag(J^{T}*J))⁻¹*J^{T}*R, wherein diag(J^{T}*J) is configured to adjust an effect of a parameter change on the increment direction, and λ is an adjustment factor for controlling a size of a stride, namely reducing by λ if a fitting result after parameter updating becomes better and increasing by λ if a fitting result after parameter updating becomes worse;
where Δp represents a variation of a parameter, which is a column vector for indicating how the parameter is adjusted to minimize a residual at a current parameter value, λ represents a regularization parameter for controlling an intensity of regularization, J^{T} represents a transpose of the Jacobian matrix J; J^{T}*J represents a product of the transpose of the Jacobian matrix J and the Jacobian matrix, diag(J^{T}*J) represents converting the product of the transpose of the Jacobian matrix J and the Jacobian matrix to a diagonal matrix, namely only retaining elements in a main diagonal, J^{T}*R represents a product of the transpose of the Jacobian matrix J and a residual vector R, and (J^{T}*J+λ*diag(J^{T}*J))⁻¹ represents an inverse matrix of the matrix (J^{T}*J+λ*diag(J^{T}*J)).

9. The method for identifying a type of a shale laminaset based on electrical imaging logging according to claim 8, further comprising,
calculating a quadratic sum of a new residual vector after parameter estimated values are updated, and compared with a last value, if the quadratic sum is less than the last value and a preset convergence threshold is reached, algorithm iteration is stopped, and parameter estimation is regarded as having converged, if the quadratic sum is less than the last value and the convergence threshold is not reached, the iteration is continued, parameter values are updated, and residuals are recalculated; if the quadratic sum is greater than the last value, a stride of parameter updating is adjusted according to current parameter estimated values and residual vector, and the iteration is continued, with a calculation model:
$$condition 5 = \{ {R}_{last}^{2} - ( Y - {f ( x ; p + Δ p )}^{2} ) > threshold ;$$
where R²ₗₐₛₜ represents a quadratic sum of a residual vector of a last iteration; Y−f(x;p+Δp)² represents the quadratic sum of the new residual vector calculated after the parameter values are updated; threshold represents the preset convergence threshold for determining a change in residual is small enough, and if the change in residual is less than the threshold, the parameter estimated is regarded as having converged; condition5 represents an iteration stopping condition, if R²ₗₐₛₜ minus the quadratic sum of the new residual vector is greater than the threshold, the iteration is continued; otherwise, the iteration is stopped.
